(19) United States
(12) Patent Application Publication
(10) Pub. No.: US 2025/0074510 A1
(43) Pub. Date: Mar. 6, 2025

(54) EXTENDABLE COUPLING CONTAINER TRAILER/CHASSIS WITH PNEUMATIC SUSPENSION & FIFTH WHEEL

(71) Applicant: DHILLON'S INTERMODAL SERVICES INC., Caledon (CA)

(72) Inventor: Manmit DHILLON, Brampton (CA)

(21) Appl. No.: 18/286,044

(22) PCT Filed: Apr. 8, 2021
(86) PCT No.: PCT/CA2021/000011

§ 371 Date: Oct. 6, 2023

(51) Int. Cl. B62D 21/14; B62D 53/08

(52) U.S. Cl. CPC B62D 21/14; B62D 53/08

(57) ABSTRACT

A strengthened extendable container chassis frame that will be used to pick up either a 20′. 40′, or a 45′ container which will also provide the option to couple with another trailer using the pneumatic slide out fifth wheel on the strengthened subframe.

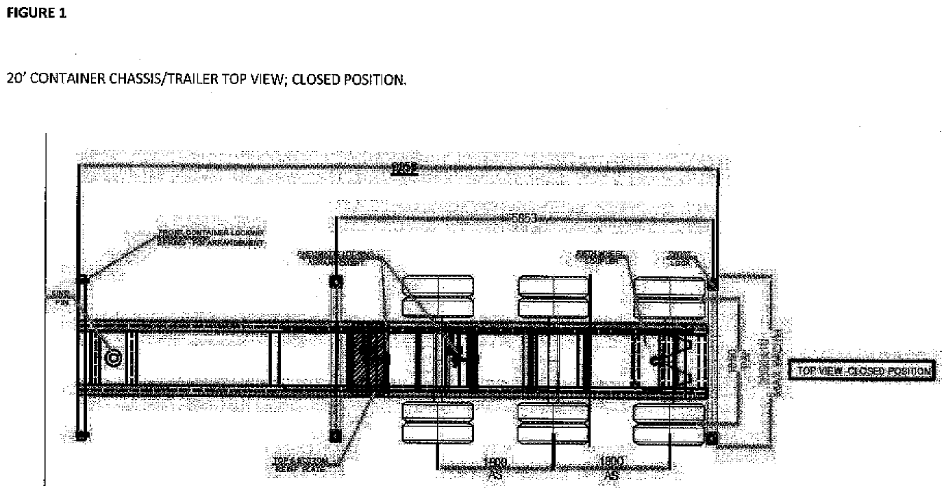

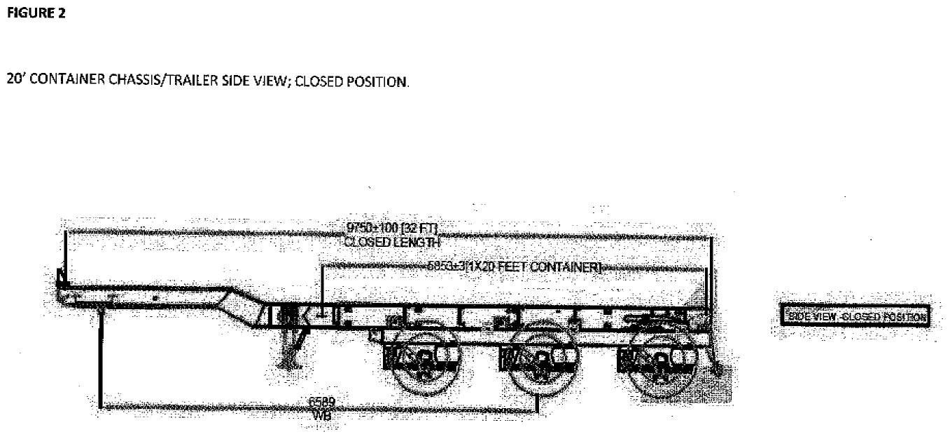

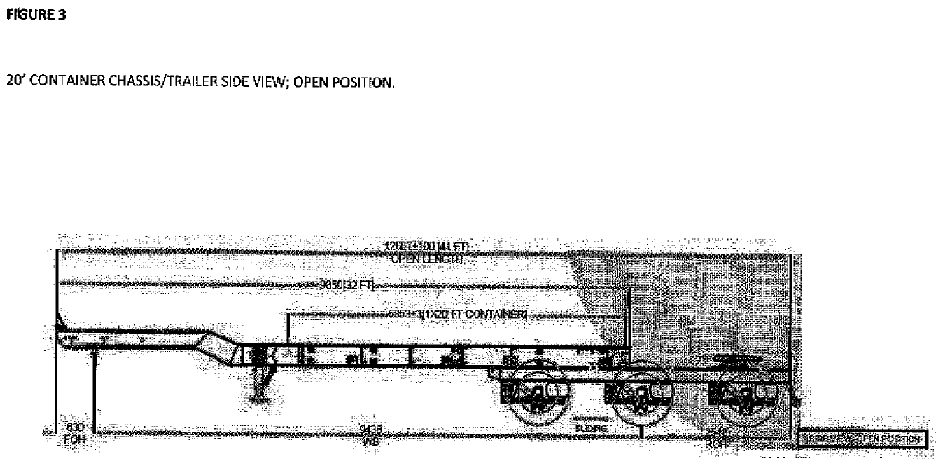

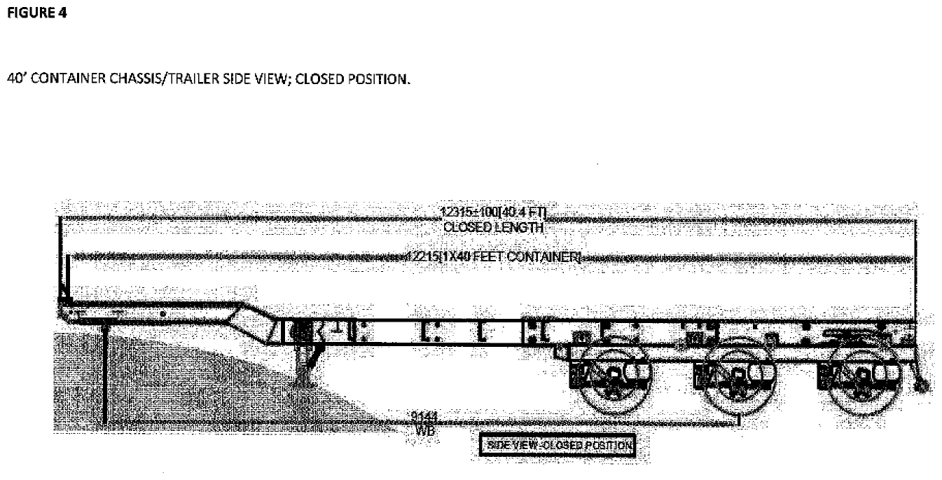

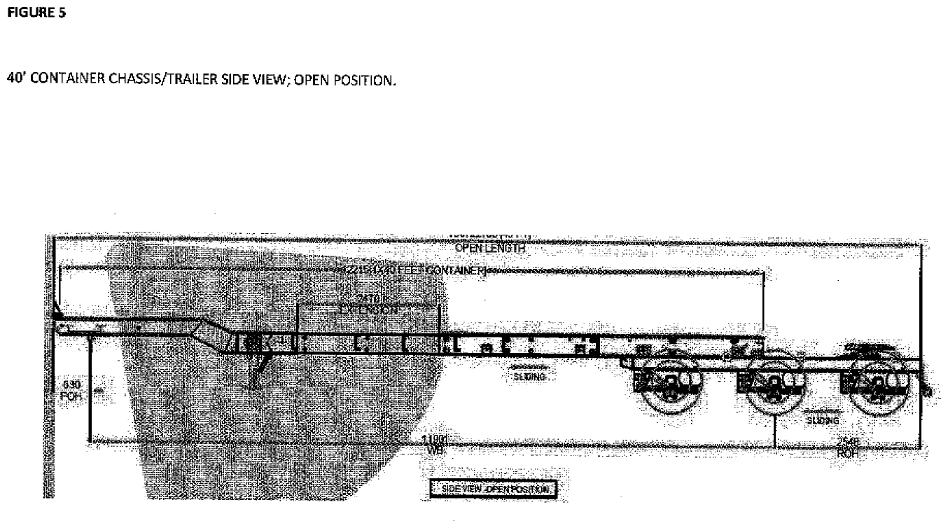

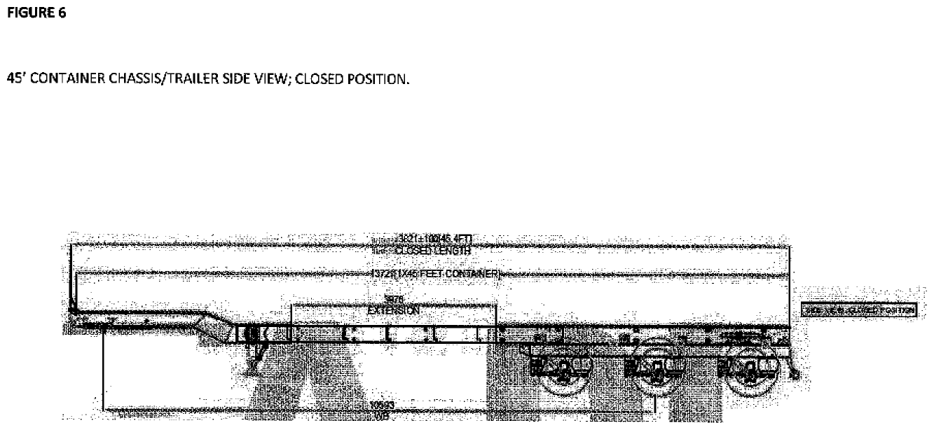

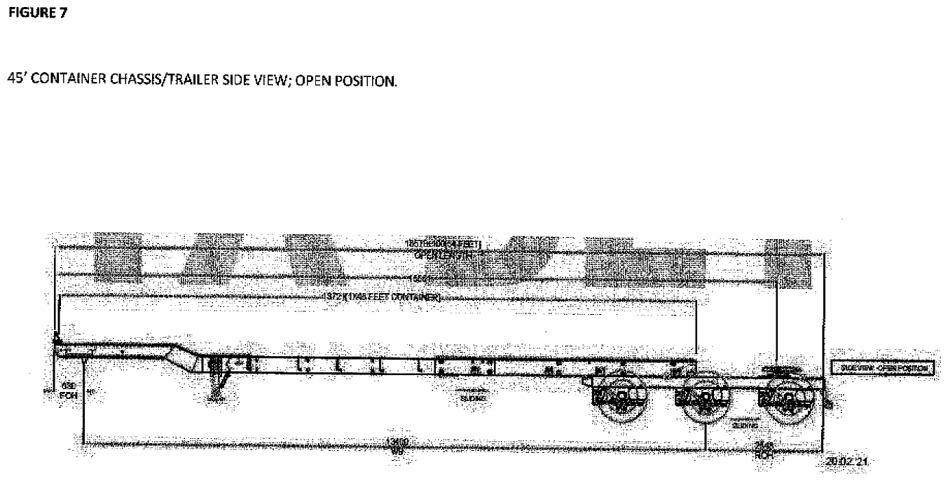

### BACKGROUND OF THE INVENTION

### 1. Field of the Invention

This invention relates to the extendable frame of the container trailers/chassis and more particularly to the subframe sliding fifth wheel addition with the pneumatic suspension system.

### 2. Scope of the Prior Art

The lead (slide out fifth wheel) container chassis has typically been seen on only a 20′ container chassis/trailer which does not take into consideration now the updated Long Combination Vehicles rules in place for commercial highway travels.

The extendable container trailer/chassis frame has only been transporting one container at a time, thus causing more traffic and delays in rail yards and roads. Prior solutions to the problem have been directed to additional beam placements, however the container placed at the front doors would have no access and would then need to be rearranged with the container placed at the rear.

### SUMMARY OF THE INVENTION

The invention is directed to improve the supply chain by strengthening an extendable container trailer/chassis frame and add a pneumatic system to the subframe which would allow a fifth wheel to slide out (and close) to allow coupling to another trailer/chassis.

The pneumatic system would allow for extending the frame to either accommodate a 20′, 40′ or a 45′ container. The system would also allow to slide out the fifth wheel and provide air supply the to coupling/connecting of the rear trailer/chassis.

As the pneumatic system would be flowing through the chassis, an air suspension system has been selected as the safest and smoothest method for this equipment.

### BREIF DESCRIPTION OF THE DRAWINGS

All three size of the extendable frame were shown together on the GA drawing which consists of:

OPTION 1, 20 Foot Container; shows the top & side view with the fifth wheel in the closed position the container would be placed on top of. There is also an open position of the side which shows the fifth wheel on the subframe slid out towards the rear. which could couple to another trailer/chassis.

OPTION 2, 40 Foot Container; shows the sideview of the trailer/chassis frame stretched to 40′ with the fifth wheel in closed and open position (with the subframe slid out towards the rear, which could couple to another trailer/chassis).

OPTION 3, 45 Foot Container; shows the sideview of the trailer/chassis frame stretched to 45′ with the fifth wheel in closed and open position (with the subframe slid out towards the rear, which could couple to another trailer/chassis).

1. Container trailer/chassis comprising:
a pneumatic system opening and closing pin locks on the frame to slid or shrink the trailer/chassis;
a pneumatic system that allows for the fifth wheel to slide in and out on the subframe;
the subframe to allow air supply to the coupling trailer; and
a pneumatic suspension system.

2. Extendable trailer/chassis frame comprising.
a pneumatic system that allows for the fifth wheel to slide in and out on the subframe; which the subframe provides power to the connecting trailer.

3. Container Chassis frame comprising;
frame to extended and shrink to accommodate container's between and on 20′ to 45′; with a subframe to slide in and out with a fifth wheel to couple to another trailer or chassis; and
subframe provide connection to power the coupling trailer.

4. A pneumatic system on container trailer/chassis comprising;
Extendable frame;
Extendable subframe; with
Supply to provide the connecting trailer; and
Air suspension.
